(19) United States
(12) Patent Application Publication
(10) Pub. No.: US 2009/0008237 A1
(43) Pub. Date: Jan. 8, 2009

(54) Device for producing active material for lithium secondary battery and method for producing active material for lithium secondary battery, method for manufacturing electrode for lithium secondary battery, and method for manufacturing lithium secondary battery

(76) Inventors: Toshikazu Yoshida, Moriguchi-city (JP); Tetsuyuki Murata, Moriguchi-city (JP); Shigeki Matsuta, Moriguchi-city (JP); Yasunobu Iwami, Moriguchi-city (JP); Yoshinori Kida, Moriguchi-city (JP); Hiroyuki Akita, Kobe-city (JP); Koji Hasumi, Saitama-city (JP)

Correspondence Address: KUBOVCIK & KUBOVCIK, SUITE 1105, 1215 SOUTH CLARK STREET, ARLINGTON, VA, 22202, US

(21) Appl. No.: 12/216,372

(22) Filed: Jul. 2, 2008

(30) Foreign Application Priority Data
Jul. 6, 2007 (JP) 2007-177862

(51) Int. Cl. C01B 25/00; B01J 19/08

(52) U.S. Cl. 204/157.45; 422/129; 204/158.2

(57) ABSTRACT

Provided is a method for producing an active material for a lithium secondary battery to enable efficient removal of iron impurities, which would become a problem in production of an active material for a lithium secondary battery, and attain a high quality. The method includes removing iron impurities in an active material for a lithium secondary battery by means of magnetic force. With this method, use of a magnetic force-generating device within a recess portion, which composes at least one part of the recess portion, enables efficient removal of only iron impurities. Thus, it is expected that a voltage drop caused by dissolution of iron compounds, i.e. impurities in a positive electrode, and their migration to a negative electrode in a battery, and decreases in charge and discharge efficiencies and a voltage drop owing to precipitation of lithium can be suppressed.

### BACKGROUND OF THE INVENTION

1. Field of the Invention

The present invention relates to a method for producing an active material used for a lithium secondary battery, a method for manufacturing an electrode for a lithium secondary battery, and a method for manufacturing a lithium secondary battery, which are characterized in that the amount of iron as an impurity in the active material is reduced by use of magnetic force. The reduction in the amount of an impurity can be considered to make it possible: to suppress a voltage drop caused by the iron impurities in a positive electrode dissolving in a battery electrolyte and migrating to a negative electrode inside a battery; and to suppress decreases in charge and discharge efficiencies and a voltage drop owing to precipitation of lithium.

2. Description of the Related Art

In a nonaqueous electrolyte secondary battery commonly used at present, LiCoO₂ is used for a positive electrode, and a lithium metal, lithium alloy or a carbon material which can absorb, accumulate and discharge lithium is used for a negative electrode. Further, in the battery, a solution containing an organic solvent, such as ethylene carbonate or diethyl carbonate, with an electrolyte consisting of a lithium salt, e.g. LiBF₄, and LiPF₆, dissolved therein is used as a non aqueous electrolyte. It is considered that when the iron impurities are contained in the active material, a voltage drop attributed to the iron impurities in a positive electrode dissolving in a battery electrolyte and migrating to a negative electrode inside a battery, and decreases in charge and discharge efficiencies and a voltage drop owing to precipitation of lithium will occur.

It is proposed in WO2005/051840 that LiFePO₄ is produced by utilizing the following reaction to mix raw materials, synthesizing LiFePO₄ by means of the hydrothermal method, and then rinsing the product with distilled water:

FeSO₄.7H₂O+H₃PO₄+3LiOH.H₂O→LiFePO₄+Li₂SO₄+11H₂O.

However, water-insoluble impurities such as iron and iron alloy cannot be removed by the rinse using distilled water as stated in WO2005/051840, and the impurities will end up remaining in the active material. When magnetic iron impurities, which are impurities in a positive electrode like this, dissolve in a battery electrolyte and migrate to a negative electrode in a battery, a voltage drop will occur. In addition, precipitation of lithium will cause decreases in charge and discharge efficiencies and a voltage drop.

JP-A-2003-123742 contains the description about a method for manufacturing a plate electrode for a nonaqueous electrolyte secondary battery including mixing a positive electrode active material, an electrically-conducting agent, and binding agent in a solvent thereby to prepare a slurry, and applying the resultant mixture on a current collector to dry it, in which it is described that the method includes the step of removing iron powder and/or SUS powder by means of magnetic force before the step of applying the slurry on the current collector.

Further, JP-A-2004-223333 discloses a way to remove magnetic impurities by supplying a filtering-target toward a rod-shaped magnet so that it flows along the magnet sufficiently in contact with the magnet.

JP-A-2002-370047 discloses a way to remove magnetic impurities by means of a number of magnet devices provided on peripheral portions of a tubular body.

As described above, it is difficult to remove iron impurities with the means disclosed in WO2005/051840. Further, as for the ways to remove iron impurities proposed in JP-A-2003-123742, JP-A-2004-223333 and JP-A-2002-370047, it is difficult to remove iron impurities efficiently because an active material flowing through a flow path unsticks iron impurities having been stuck on a predetermined member or part. Particularly, in the case of removing iron impurities in a para magnetic material, such as LiFePO₄, an active material impedes deposition of iron impurities, and therefore it is difficult to remove iron impurities efficiently.

### SUMMARY OF THE INVENTION

Therefore, the invention aims to overcome the problems as described above, and an object of the invention is to provide an active material for a lithium secondary battery, from which iron impurities have been removed to a higher level efficiently, an electrode for a lithium secondary battery using the active material, and a lithium secondary battery using the electrode.

According to a first aspect of the invention, a device for producing an active material for a lithium secondary battery is provided, which removes iron impurities in the active material or its raw material by means of magnetic force. The device is characterized by including: a flow path which the active material or its raw material passes through, the flow path having at least one recess portion laid out along the flow path; and a magnetic force-generating device disposed at the recess portion so as to compose at least one part of the recess portion.

As magnetic iron impurities are collected in the recess portion by the magnetic force-generating device, the device associated with the invention is significantly improved in hindering the active material flowing inside the flow path from unsticking the magnetic iron impurities, and the deposition of relevant impurities.

Also, the device associated with the invention may be arranged so that the active material or its raw material is made to pass through a tubular member, and in the tubular member, a recess portion with a magnetic force-generating device disposed at the recess portion so as to compose at least one part of the recess portion is laid out, whereby iron impurities are removed.

According to a second aspect of the invention, a method for producing an active material is provided, which includes removing iron impurities by use of the device for producing an active material according to the first aspect.

The active material produced by the method associated with the invention is further processed to make an electrode, which is used as an electrode for a lithium secondary battery.

In regard to a lithium secondary battery using, for its positive electrode, the active material produced by the method associated with the invention, iron impurities in the active material are removed more efficiently in comparison with a lithium secondary battery manufactured by another method. Thus, a voltage drop caused by dissolution of iron impurities and their migration to a negative electrode in a battery, and decreases in charge and discharge efficiencies and a voltage drop owing to precipitation of lithium can be suppressed.

The following materials can be used according to the invention: positive electrode active materials including e.g. a lithium-containing transition metal oxide such as LiCoO₂, LiNiO₂, and LiNi_{1/3}Co_{1/3}Mn_{1/3}O₂, and a lithium complex compound expressed by a chemical formula of LiMPO, where M is at least one element selected from among cobalt (Co), nickel (Ni), manganese (Mn) and iron (Fe); negative electrode active materials including e.g. a carbon material which can absorb and release lithium. Particularly, the invention exerts an effect when using a para magnetic material such as LiFePO₄.

Further, the invention can be applied to removal of iron impurities from electrically-conducting agents including e.g. a carbon material such as acetylene black, ketjen black, natural graphite, artificial graphite, and vapor grown carbon fiber.

The structure having a recess portion in a flow path according to the invention is not limited to the embodiment hereof. A structure having recess and projection portions, a meshed structure and the like may be used instead.

According to a third aspect of the invention, in the method for producing an active material, the active material is contained in a slurry.

According to the first and second aspects of the invention, magnetic iron impurities in an active material or its raw material are collected in a recess portion by a magnetic force-generating device, and therefore iron impurities in the active material or its raw material can be removed efficiently.

According to a third aspect of the invention, a slurry containing the active material is prepared, thereby to increase the fluidity of the active material. As a result, it is expected that iron impurities can be removed more efficiently.

### BRIEF DESCRIPTION OF THE DRAWINGS

FIG. 1 is a diagrammatic illustration for explaining removal of iron impurities in a slurry containing an active material by means of a magnet according to an embodiment of the invention;

FIG. 2 is a diagrammatic illustration showing a jig having the magnet buried therein and used in the embodiment;

FIG. 3 is a diagrammatic illustration for explaining removal of iron impurities in the slurry containing an active material by means of a magnet in a comparative example with the embodiment of the invention;

FIG. 4 is a diagrammatic illustration showing a jig having the magnet buried therein in the comparative example;

FIG. 5 is a photograph of a SEM image of deposits on a magnet of the jig used in a first example associated with the invention;

FIG. 6 is a photograph of a SEM image of deposits on a magnet of the jig used in the comparative example; and

FIG. 7 is a diagrammatic illustration showing another embodiment of a device for producing in accordance with the invention.

### DESCRIPTION OF THE PREFERRED EMBODIMENTS

The examples associated with preferred embodiments of the invention will be described below. However, the invention is not limited to the examples below at all. Various changes and modifications hereof may be made without departing from the subject matter hereof.

### EMBODIMENTS

### Example 1

### Sample Preparation

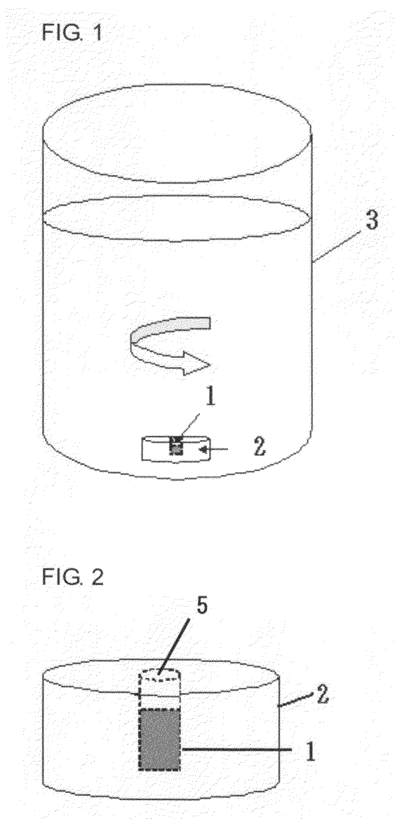

Five hundred grams of LiFePO₄ and a jig 2 having a recess portion 5 and a magnet 1 disposed in the recess portion 5 are put in a container 3 holding 1500 milliliters of water so that the recess portion 5 of the jig 2 is opening vertically upward, followed by stirring the mixture for ten minutes in a circumferential direction in parallel with the bottom face of the container 3 (see FIGS. 1 and 2). Herein, the jig 2 is composed of a resin structure which measures 20 mm in diameter and 10 mm in height, and has a hole having a diameter of 2 mm and a depth of 2 mm and formed in a central portion of the jig; in the hole, the magnet made of samarium cobalt and measuring 2 mm in diameter and 5 mm in height is buried.

### Comparative Example 1

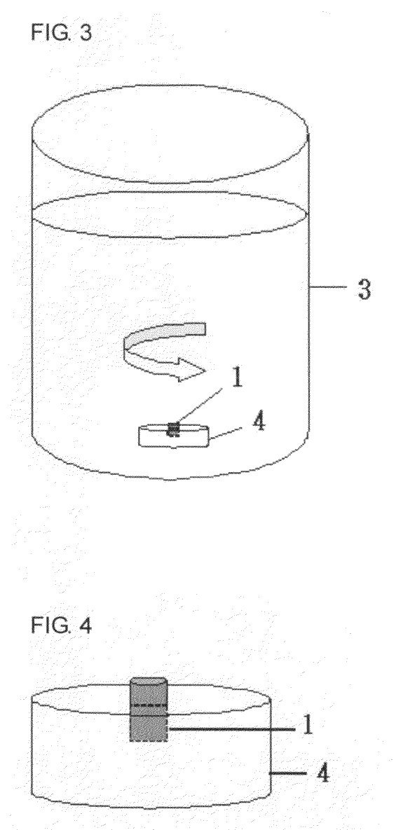

The arrangement made in this example is the same as that made in the first example except that a jig 4 having a magnet buried therein is put in the container so that a portion of the magnet protruding from the jig 4 is located on an upper side of the jig 4. Herein, the jig 4 is composed of a resin structure which measures 20 mm in diameter and 10 mm in height and has a hole having a diameter of 2 mm and a depth of 2 mm and formed in a central portion of the jig; in the hole, the magnet which is made of samarium cobalt and measures 2 mm in diameter and 5 mm in height is set so that it protrudes from the jig by 2 mm (see FIGS. 3 and 4).

<Sample Analysis>

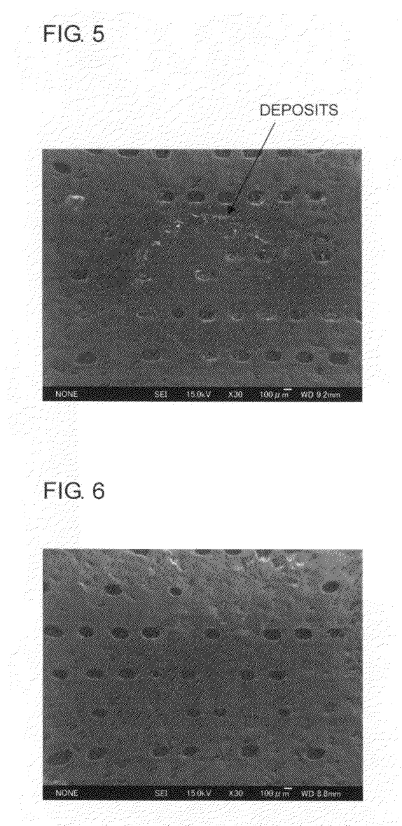

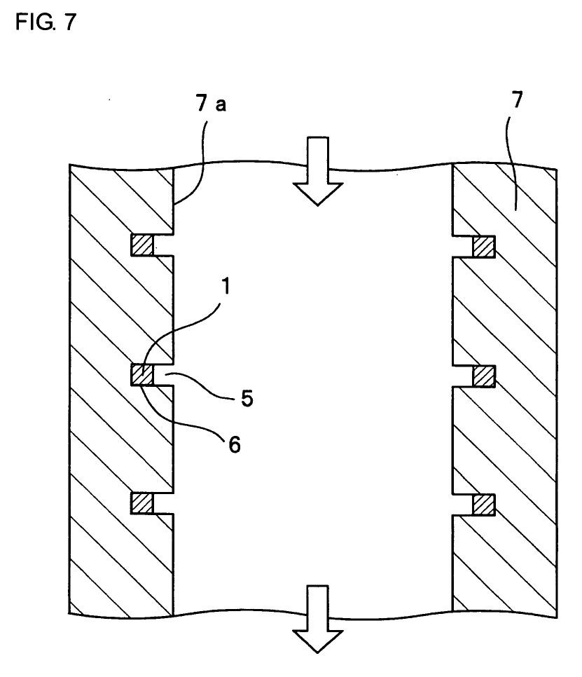

In the first example according to the embodiment hereof and the first comparative example, deposits on the magnet of each jig were observed by a SEM-EDX, i.e. scanning electron microscope equipped with an energy dispersive X-ray analyzer (see FIGS. 5 and 6). The deposits on each magnet were transferred to a surface of an adhesive tape by putting the adhesive tape on the magnet. FIGS. 5 and 6 show the deposits on the adhesive tapes.

FIGS. 5 and 6 show that when the magnet was located in the lower position of the recess portion 5, lots of deposits were observed around perimeter on the bottom of the recess portion. However, it was shown that when the magnet was protruded from the surface of the jig, few deposits were observed. When the deposits were observed with the SEM-EDX, iron was detected as a main component, where as phosphorus was not detected. Judging from this, it is considered that LiFePO₄ had not been deposited.

From this fact, it can be understood that in the case of removing iron impurities in LiFePO₄ by means of magnetic force, it is preferable to place a magnetic force-generating device at the recess portion so as to compose at least one part of the recess portion. In the case where the magnetic force-generating device protrudes from the surface or the case where the end of the device facing the outside is located at the same level with the surface, it is difficult to remove the iron impurities efficiently. This is because it is considered that an active material flowing through a flow path impinges on iron impurities sticking on the inside of the path thereby to unstick the sticking impurities. Further, in the case where the magnetic force-generating device is disposed in the recess portion so as to compose at least one part of the recess portion, the iron impurities can be removed efficiently. Particularly, in the case of removing iron impurities in a para magnetic material such as LiFePO₄, it is considered that a magnetic force-generating device placed in the recess portion so as to compose at least one part of the recess portion enables efficient removal of iron impurities, by suppressing the interruption of the active material to the deposition of iron impurities.

FIG. 7 is a diagrammatic illustration showing another embodiment of a device for producing in accordance with the invention. Referring to FIG. 7, the device for producing of the embodiment comprises a tube 7 having an inner wall surface 7a in which a slurry containing an active material passes. Therefore, a flow path which the active material passes through is formed in the tube 7. A plurality of holes 6 are formed in the inner wall surface 7a along the flow path. A magnet 1 is buried in each hole 6 to form a recess portion 5. According to the embodiment, the iron impurities contained in the active material passed through in the tube 7 can be stuck on the magnet 1 in the recess portion 5 to be removed efficiently without being unstuck owing to collision with the active material flowing in the flow path.

As stated above, it is clear that it is preferable to place a magnetic force-generating device in the recess portion so as to compose at least one part of the recess portion in the case of removing iron impurities in an active material by means of magnetic force. It is considered that the structure like this enables efficient removal of the iron impurities because the iron impurities, which have once stuck on the inside of a flow path, can be prevented from being unstuck owing to collision with the active material flowing in a flow path. Further, it is considered that in the case of removing iron impurities in a para magnetic material such as LiFePO₄, iron impurities can be removed efficiently by suppressing the interruption of the active material to the deposition of impurities. Thus, the occurrence of a voltage drop owing to dissolution of iron compounds as impurities in a positive electrode and their migration toward a negative electrode after that in a battery, and decreases in charge and discharge efficiencies and a voltage drop owing to precipitation of lithium can be suppressed.

What is claimed is:

1. A device for producing an active material for a lithium secondary battery, which removes iron impurities in the active material or its raw material by means of magnetic force, comprising:
a flow path which the active material or its raw material passes through, said flow path having at least one recess portion laid out along said flow path; and
a magnetic force-generating device disposed at said recess portion so as to compose at least one part of said recess portion.

2. A device for producing an active material for a lithium secondary battery, which removes iron impurities in the active material or its raw material by means of magnetic force, comprising:
a tube which the active material or its raw material passes through, said tube having at least one recess portion laid out along said tube; and
a magnetic force-generating device disposed at said recess portion so as to compose at least one part of said recess portion.

3. A method for producing an active material for a lithium secondary battery, by which iron impurities in the active material or its raw material are removed by means of magnetic force, comprising the step of using the device of claim 1.

4. The method for producing an active material for a lithium secondary battery of claim 3, wherein the active material includes a lithium-transition metal oxyanion compound.

5. The method for producing an active material for a lithium secondary battery of claim 4, wherein the lithium-transition metal oxyanion compound is a substance having a chemical formula of LiMPO₄, provided that M is at least one element selected from among cobalt (Co), nickel (Ni), manganese (Mn) and iron (Fe).

6. The method for producing an active material for a lithium secondary battery of claim 5, wherein the lithium-transition metal oxyanion compound is a substance having a chemical formula of LiFePO₄.

7. The method for producing an active material for a lithium secondary battery of claim 3, wherein the active material is contained in a slurry.

8. A method for manufacturing an electrode for a lithium secondary battery, comprising the step of forming the electrode by use of an active material produced by the method of claim 3.

9. A method for manufacturing a lithium secondary battery having a positive electrode, a negative electrode and a nonaqueous electrolyte, comprising the step of manufacturing at least one of the positive electrode and negative electrode by the method of claim 8.

10. A method for producing an active material for a lithium secondary battery, by which iron impurities in the active material or its raw material are removed by means of magnetic force, comprising the step of using the device of claim 2.

11. The method for producing an active material for a lithium secondary battery of claim 10, wherein the active material includes a lithium-transition metal oxyanion compound.

12. The method for producing an active material for a lithium secondary battery of claim 11, wherein the lithium-transition metal oxyanion compound is a substance having a chemical formula of LiMPO₄, provided that M is at least one element selected from among cobalt (Co), nickel (Ni), manganese (Mn) and iron (Fe).

13. The method for producing an active material for a lithium secondary battery of claim 12, wherein the lithium-transition metal oxyanion compound is a substance having a chemical formula of LiFePO₄.

14. The method for producing an active material for a lithium secondary battery of claim 10, wherein the active material is contained in a slurry.

15. A method for manufacturing an electrode for a lithium secondary battery, comprising the step of forming the electrode by use of an active material produced by the method of claim 10.

16. A method for manufacturing a lithium secondary battery having a positive electrode, a negative electrode and a nonaqueous electrolyte, comprising the step of manufacturing at least one of the positive electrode and negative electrode by the method of claim 15.
